(19) United States
(12) Patent Application Publication
(10) Pub. No.: US 2004/0103030 A1
(43) Pub. Date: May 27, 2004

(54) Method and system for enhancing world wide web-based directory listings

(76) Inventors: Perry Evans, Littleton, CO (US); Jearld Waitkus, Santa Clara, CA (US)

Correspondence Address: BLAKELY, SOKOLOFF, TAYLOR & ZAFMAN LLP, Seventh Floor, 12400 Wilshire Boulevard, Los Angeles, CA, 90025, US

(21) Appl. No.: 10/639,673

(22) Filed: Aug. 12, 2003

Related U.S. Application Data
(60) Provisional application No. 60/403,111, filed on Aug. 12, 2002.

(51) Int. Cl. G06F 17/60; G06F 7/00; G06F 17/00

(52) U.S. Cl. 705/14; 707/104.1

(57) ABSTRACT

According to one embodiment, a platform is disclosed. The platform includes one or more service modules to generate marketing content for directory listings, an application programming interface (API) communicatively coupled to interface with the one or more service modules, and a database to store data associated with the marketing content.

This application claims priority from provisional application No. 60/403,111, filed on Aug. 12, 2002, entitled “Method And System For Enhancing World Wide Web—Based Directory Listings”, currently pending, and herein incorporated by reference.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to a computer-based procedure for delivering on-line marketing applications to marketplace providers (such as world wide web-based directories and communication service providers) for resale to small and medium enterprises.

### BACKGROUND

For decades, consumers wishing to locate service providers in a particular industry or market segment have turned to hard copy directories such as the familiar yellow pages. Indeed, this very term (descriptive of the page color traditionally used by publishers of such directories to identify commercial service provider listings) has become synonymous with a listing of merchants and other service providers. Today, these directories have migrated to the World Wide Web to become known as on-line directories.

On-line directories provide an alternative or companion advertising tool for merchants wishing to alert potential customers of their availability. Such merchants typically pay on-line directory providers a fee for listings in the on-line directory and such listings are displayed to users in response to queries submitted by those users.

More specifically, the on-line directory provider maintains a large database of merchant listings (perhaps indexed by category(ies), key word(s), location, etc.). Users access the database through a graphical user interface (e.g., in the form of a Web page displayed in a browser window at the user's computer site) and submit queries to the database.

In response to these queries, the computer system hosting the on-line directory (or an associated system) searches the database and returns those listings that match one or more criteria set forth in the user's query. Once such a list has been returned, the user can search for a particular merchant that satisfies the user's need.

Although the above-described scheme generally works well, on-line directories do suffer from several drawbacks. For example, users familiar with the typical yellow page advertising style, which often incorporates large graphical items and descriptive text regarding the merchant and/or the services provided thereby, are often disappointed with the on-line listings which typically provide minimal information such as a merchant's name and address.

The on-line listing thus affords little opportunity for the user to compare one merchant to another. At best, the user may be provided with a hyperlink to one or more merchants' individual Web sites, but a detailed review of each of these sites would be time consuming and many users simply avoid such reviews.

Another drawback of current on-line directory listings is that they provide little or no opportunity for the merchant to customize his or her listing. Most often, the listings are text-only. This can be upsetting for a merchant that has invested in off-line advertisements that incorporate artwork of some form, and through which the merchant may seek to obtain brand or name recognition. If such artwork cannot be used to enhance an on-line directory listing, many merchants may decide that such a listing is not desirable inasmuch as it will not lead to significant return on investment.

This latter point reveals a current problem for on-line service directory providers. With small business spending on electronic applications expected to grow significantly in the United States and elsewhere, directory publishers and communication service providers—indeed, all marketplace providers—have a significant business opportunity. But finding ways to sell the Web to small and medium enterprises (SMEs) has been a major challenge in recent years. Whether trying to match the success of a print directory product online, or leveraging existing SME relationships into increased revenue, the industry has struggled to identify the right product mix that delivers high return-on-investment at a fair price.

Finally, SMEs have also been challenged. Many that have invested in on-line advertising products have been disappointed in the results. What's more, some SMEs have avoided or quit on-line marketing activities because they are intimidated by the technology or lack the time and resources to focus on a task that may not result in increased sales. What is needed therefore is a method and system that takes advantage of the dynamic, interactive promise of the Internet, yet accommodates the realities of SME priorities.

### BRIEF DESCRIPTION OF THE DRAWINGS

The invention is illustrated by way of example and not limitation in the figures of the accompanying drawings, in which like references indicate similar elements, and in which:

FIG. 1 illustrates one embodiment of a platform;

FIG. 2 illustrates one embodiment of a network;

FIG. 3 is a screen shot illustrating one embodiment of an Active Marketing Page;

FIG. 4 is a screen shot illustrating one embodiment of an inline-ad;

FIG. 5 is a screen shot illustrating another embodiment of an in-line ad; and

FIG. 6 illustrates one embodiment of a computer system.

### DETAILED DESCRIPTION

Described herein is a method and system for delivering on-line marketing applications to marketplace providers (such as world wide web-based directories and communication service providers) for resale to SMEs. The present invention provides a single-platform approach that allows for parallel publishing of advertising resources across on-line directories, SME web sites and targeted e-mail advertising campaigns.

Because SMEs are able to cross-market using the same resources (i.e., the same sale message on the directory page, in the Web site, and in outgoing e-mails) their exposure and return-on-investment is enhanced over processes of the past. Further, the present platform (which in one embodiment comprises computer software for execution at one or more computer sites) is designed to integrate with existing on-line directories. Thus, minimal modification to existing on-line directory computer systems is required.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

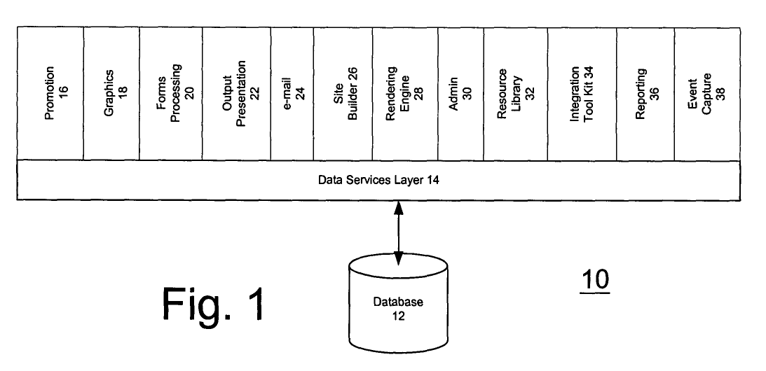

FIG. 1 illustrates one embodiment of a software architecture platform 10. Many different modules are shown in this example to provide the reader with an appreciation of the rich nature of the services that the platform is capable of providing. It should be recognized, however, that the present invention may be practiced with some of these modules removed or others added.

At the core of platform 10, exists a database 12. Database 12 may be a conventional relational database, such as an Oracle database or other structured query language (SQL) compliant database. The database serves as a common repository of data for the present platform and its use in responding to user inquiries is discussed below.

Operating as an interface to the database is a data services layer 14. This data services layer 14 provides an application programming interface (API) for the remaining modules. Like other such layers in other software platforms, the data services layer 14 receives requests from the other software modules and provides the requests to database 12 in a format and context which database 12 is capable of handling. Responses from database 12 are passed through the data services layer 14, where they may be reformatted into structures and contexts, which the requesting software module can understand.

The remaining software modules reside on top of the data services layer 14. Among these modules (and in no particular order) is a promotion module 16. Promotion module 16 enables a merchant (or a merchant's agent, such as a customer service representative of the on-line directory provider) to schedule one or more advertising promotions to appear in connection with the merchant's on-line directory listing. These promotions may appear in any of several forms, such as one or more screens within an active marketing page associated with the merchant's on-line listing.

Active marketing pages (AMPs) are secondary information pages associated with a merchant's on-line directory listing. Secondary information pages in on-line directories have historically centered on standard reference information about a business (business hours and accepted payment methods for example), but have done little to promote buyer-seller interaction and active promotion.

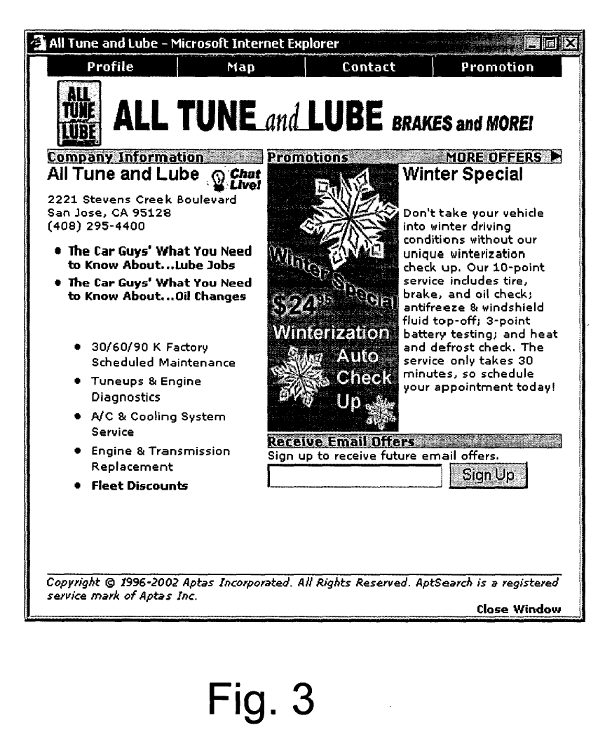

FIG. 3 is a screen shot illustrating one embodiment of an AMP. The present AMP is designed to be an SME's “second page” and provides a modular set of ways to package descriptive business information with active marketing applications for promotion and communications. AMPs encompass standard business descriptions and mapping services. In addition, AMPs expand the second page concept to drive consumer action and improve the value as a truly active page for the SME to market themselves.

In one embodiment, an AMP includes descriptive business information, map and driving directions to the business location, promotions, several ways to contact the business, such as request forms and an opportunity to join the business email list. Further, unconventional methods to contact the business such as chat and push-to-talk (voice over Internet) capabilities may be included. An AMP can also feature information or links to third-party products.

Therefore, an AMP may function as the single point of contact for detailed, timely, relevant information about each SME (i.e., without having to direct the user to the merchant's actual web site). AMPs may also be initiated through a link on a business website, providing one more way to lead potential customers to this key promotion and communication center.

AMPs introduce potential customers to the who, what, where, when, and why of each SME business. Moreover, AMPs offer multiple information and communication capabilities within the same pop-up window. Pop-up windows enable users to remain at the directory's search results page to learn more about the SME.

In addition, AMPs display detailed business information such as address, description, business hours, accepted payment methods, and map and driving directions and provide an excellent means of actively promoting highlights and specials contained on websites of larger businesses. Further, AMPs offer active communication options including request forms and email newsletter signup, with a multi-panel design that allows for expansion of integrated real-time interaction services, such as instant messaging and telephony.

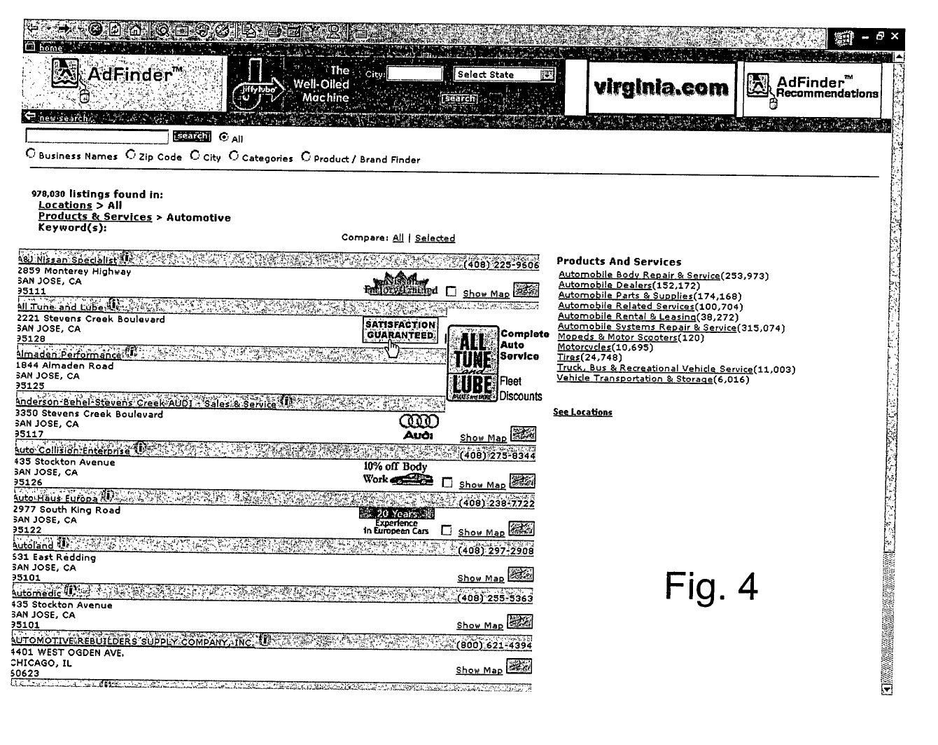

In addition to AMPS, promotion module 16 may be used to schedule in-line ads to be associated with an SME's on-line directory listing. FIG. 4 is a screen shot illustrating one embodiment of an inline-ad. For SMEs who want to differentiate their businesses in an on-line directory, paying for a top-placed directory listing is the first step.

The next step is to let SMEs promote their businesses with their own messages through advertisements linked to their directory listings. Whether the ad includes a business logo, this month's special, or a unique marketing message, an inline ad promotes the business in a direct, graphic, and up-front way. Inline ads are also clickable, allowing consumers to take the next steps: viewing the SME's business details and promotions (e.g., in an AMP), linking to the SME's website, or initiating an interactive communication session.

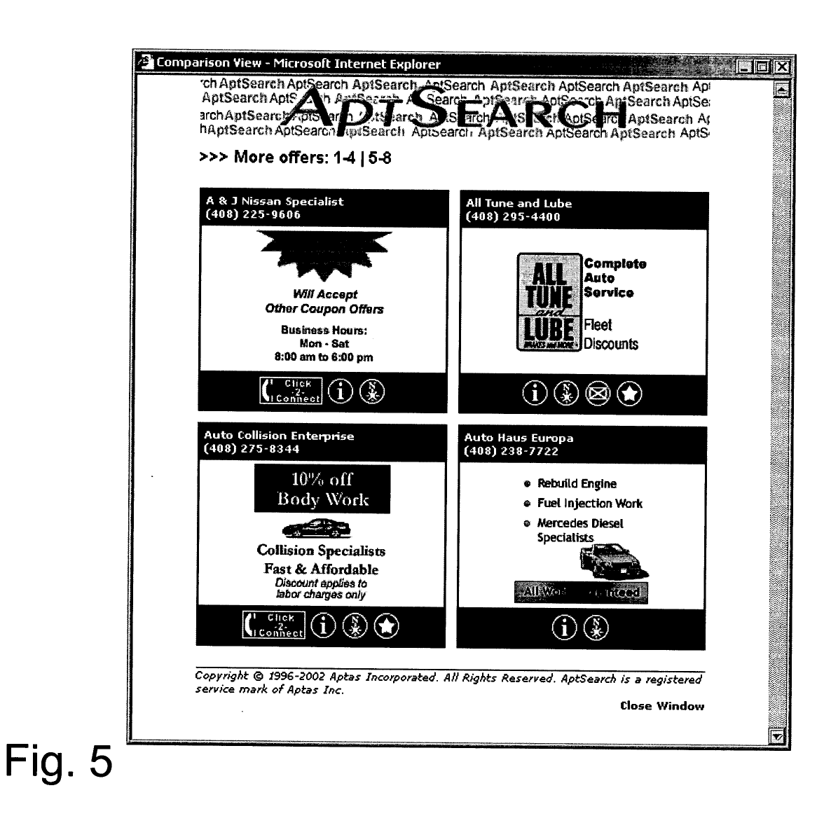

Inline ads may show business logos, slogans, key messages, time-sensitive or seasonal promotions, and special events; in other words, anything that transmits the business message to consumers. Inline ads are scheduled to display and hide at predetermined times (set via the promotion module 16) and can be tracked to measure the number of times they are displayed or clicked. In one embodiment, inline ads display extended information for multiple businesses, adding comparison shopping relevance and value to the consumer and increased value to the SME. FIG. 5 is a screen shot illustrating one embodiment of an inline-ad used for comparison shopping.

In other embodiments, inline ads function as a stand-alone graphic embellishment to a directory listing or become the active gateway to actionable content, linking the online customer to an SME's website, AMP, or email-sign-up page. Therefore, inline ads provide graphic or text-based ads published next to the SME's online directory listing. Inline ads are also schedulable ads, providing up-to-date information.

The ads may also link to an SME's active marketing page, business website, a featured promotion, or an email sign-up page. Inline ads easy to provision with ad templates and image libraries. An optional rollover ad format provides ample business information without requiring consumers to leave the search results page. Further, inline ads support Internet Advertising Bureau standard ad sizes and provides clear upgrade path to other online products.

In addition to inline ads and active marketing pages, tag lines are provided as additions to directory service listings. In this context, tag lines are words or short phrases that can be scheduled to appear in conjunction with an SME's directory listing as means to catch a user's attention and/or to highlight an aspect of the SME's service or product offering.

Another software module is graphics module 18. This may be a conventional set of tools that allows manipulation of graphic images (e.g., to design custom advertisements for the advertisers). A forms processing module 20 acts as a form handler to receive input from users interacting with the platform (e.g., during an ad creation process, during a scheduling process, or during a user interaction with an on-line directory listing). A related output presentation module 22 provides a portal through which outputs from the database 12 can be directed.

An e-mail module 24 provides a communication channel for use in connection with e-mail campaigns. SMEs can take advantage of e-mail marketing techniques to develop lasting, profitable relationships with their customers. The e-mail campaign tools make use of parallel publishing ideas to incorporate content created for inline ads, AMPs or web sites into marketing campaigns delivered via e-mail on behalf of the SMEs. Content for these e-mails (or indeed for any other of the tools discussed herein) can be drawn from a collection of Web-ready graphical marketing content stored in a resource library 32.

SMEs can use the e-mail campaign tools to develop and manage customer relationships (e.g., through newsletters and e-mails in text and HTML format); marketplace providers (i.e., the directory operators) can utilize the e-mail campaign tools to help deliver new leads to SMEs. For example, marketplace providers can leverage their consumer traffic to gather consumer e-mail addresses and sell ad placements to SMEs in outgoing e-mails.

The site builder module 26 provides tools that allow SMEs to develop their own web sites, if none currently exists. Having a website is often a necessary marketing resource for many SMEs. The site builder application 26 provides streamlined web site production tools that are designed to minimize decisions, reduce the publishing steps, and keep costs down. Each website can also display sophisticated promotional and interaction features.

Features of the site builder module 26 include customizable page layouts with navigation text and graphic layout options. Site builder 26 also includes a large and expandable resource library for quick and easy website management. In one embodiment, websites can be enhanced with other presence, promotion, or interaction modules-add custom contact forms, promotions and coupons, maps, or email list sign-ups.

Further, site builder module 26 includes a comprehensive administration layer that provides complete control over creating product packages, new website styles, activity reports, and users. Moreover, site builder module 26 includes a wide variety of generic and industry-specific styles and graphics, a high degree of control over website details such as static and rollover buttons, global font control, and custom website header and real-time website management with updates that can be viewed immediately.

A rendering engine 28 is included for use in the rendering of images (e.g., web pages and the like). So too is an administration module 30. Administration module 30 is used to set up and manage SME accounts and is discussed in the accompanying exhibits.

Integration tool kit 34 is a module that includes tools for integrating the present platform with existing on-line directories. This allows directory providers to extend their offerings by adding the features provided by the present invention. In addition, the integration tool kit 34 provides means for integrating the present platform with other back office functions such as SME account provisioning, product provisioning, billing, etc.

A reporting module 36 and an event capture module 38 work to capture information regarding user interactions with the inline ads, active marketing pages and so on and provide customizable reports to the SMEs regarding traffic to their advertisements. Such tools are useful when it comes to directory providers having to show SMEs the benefits of purchasing the types of enhanced services offered by the present invention. For example, user generated events can be captured to “learn” which Tag Lines, Inline Ads, and Rollovers are most effective (from a product/service selling point of view), and thus automatically create a model that provides the most effective advertisements for SMEs.

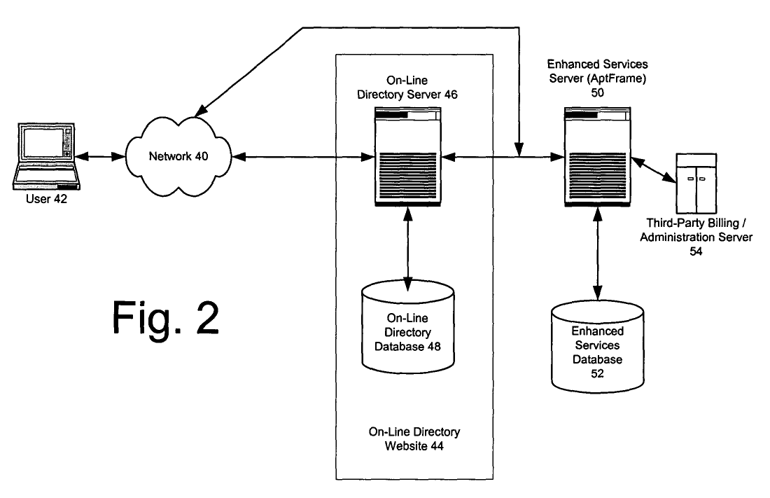

FIG. 2 illustrates one embodiment of a network 40. Network 40 may be any local area network or wide area network, and in one embodiment is the network of networks commonly referred to as the Internet. In operation, a user 42 with a personal computer configured to access network 40 (e.g., using a conventional browser or similar software application), may access the on-line directory web site 44 in an attempt to locate one or more merchants or service providers. Through one or more queries provided to on-line directory server 46, the user retrieves various merchant listings extracted from database 48 in response to the queries. These listings are presented in the form of one or more web pages.

Web pages are not, as some might believe, pages in the traditional sense. That is, modern web pages are not constrained to preconfigured sets of text and graphics. In one embodiment, web pages are sets of computer-readable instructions. These instructions are interpreted by a browser, which then locates content referred to in the instructions and displays (or renders) that content according to the instructions.

Thus, the web pages returned by server 46 are in fact instructions which tell the browser which content items to request from database 48 and how to display those items at the user's personal computer. In accordance with one embodiment, some of the instructions that make up the web page returned by server 46 will direct the browser to the enhanced services server 50. It is through this communication that enhanced content (such as the inline ads and active marketing pages discussed above) may be communicated to the user 42 for display as part of the web page returned by server 46.

To allow for the proper content to be returned, on-line directory server 46 informs the enhanced services server 50 of the various listings to be returned as part of the web page. Enhanced services server 50 uses this information to obtain the appropriate content from enhanced services database 52 and then provides same to the user 42 in response to the associated browser requests. In this way, enhanced content associated with those listings returned in response to the user query may be incorporated within the on-line directory web page seen by the user 42.

When user 42 selects an inline ad or other enhanced content included in the web page, the browser communicates directly with enhanced services server 50 for an appropriate response (e.g., displaying an AMP in a pop-up window or presenting a roll over ad in response to a cursor control event (see exhibits for further discussion)).

In some embodiments, the enhanced services server 50 may communicate with a third-party billing and/or administration server 54 (e.g., as provided by Amdocs). This allows for integration with existing SME accounts and provides a mechanism through which results of the enhanced services advertising can be tracked. Although not shown in this illustration, on-line directory server 46 may directly query enhanced services database for statistics reporting and other administrative functions. In addition, content from enhanced services database 52 may be played out through enhanced services server 50 and on-line directory server 46 in some instances (e.g., where server 46 acts as a gateway).

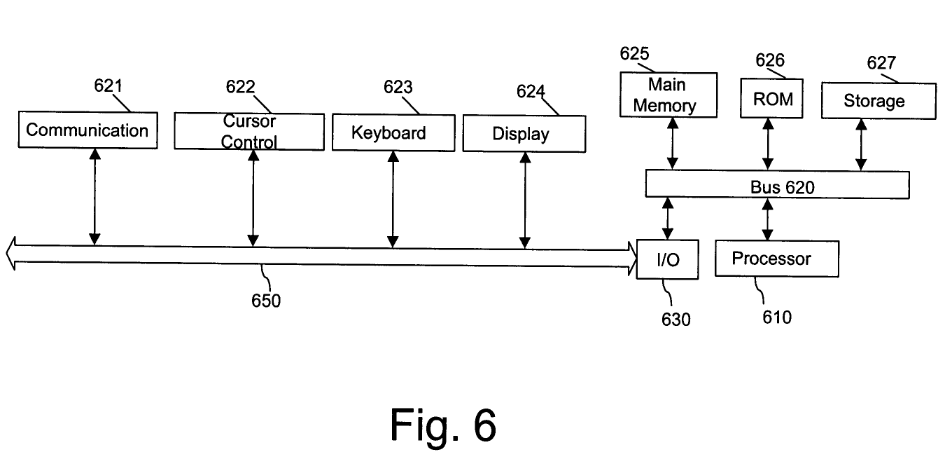

FIG. 6 is a block diagram of an exemplary computer system that may be used to perform one or more of the operations described herein. Referring to FIG. 6, computer system 600 may comprise an exemplary client 650 or server 600 computer system in which the features of the present invention may be implemented. Computer system 600 comprises a communication mechanism or bus 611 for communicating information, and a processor 612 coupled with bus 611 for processing information. Processor 612 includes a microprocessor, but is not limited to a microprocessor, such as Pentium™, PowerPC™, Alpha™, etc.

System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612. Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device which may be coupled to bus 611 is hard copy device 624, which may be used for printing instructions, data, or other information on a medium such as paper, film, or similar types of media. Furthermore, a sound recording and playback device, such as a speaker and/or microphone may optionally be coupled to bus 611 for audio interfacing with computer system 600. Note that any or all of the components of system 600 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A computer system platform comprising:
one or more service modules to generate marketing content for directory listings;
an application programming interface (API) communicatively coupled to interface with the one or more service modules; and
a database to store data associated with the marketing content.

2. The platform of claim 1 wherein the service modules comprise a promotion module to generate one or more advertising promotions to appear in connection with a directory listing.

3. The platform of claim 2 wherein the promotion module generates active marketing pages (AMPs).

4. The platform of claim 2 wherein AMPs provide descriptive business and marketing information.

5. The platform of claim 2 wherein the promotion module generates inline advertisements (ads) to be associated with directory listings.

6. The platform of claim 5 inline ads are scheduled to display and hide from directory listings at predetermined intervals.

7. The platform of claim 5 inline ads display information for multiple businesses to provide comparison shopping.

8. The platform of claim 2 wherein the promotion module generates tag lines to appear with a directory listing.

9. The platform of claim 1 wherein the service modules comprise a graphics module to generate graphic images.

10. The platform of claim 1 wherein the service modules comprise a forms processing module to interface with users interacting with the platform.

11. The platform of claim 1 wherein the service modules comprise an output presentation module to provides a portal for data transmitted from the database.

12. The platform of claim 1 wherein the service modules comprise an electronic-mail (e-mail) module.

13. The platform of claim 1 wherein the service modules comprise a site builder module to generate network sites.

14. The platform of claim 1 wherein the service modules comprise a rendering engine.

15. The platform of claim 1 wherein the service modules comprise an administration module to generate and manage accounts.

16. The platform of claim 1 wherein the service modules comprise an integration tool kit to integrate the platform with existing directory listings.

17. The platform of claim 1 wherein the service modules comprise:
a reporting module; and
an event capture module to capture information regarding user interactions with inline advertisements (ads) active marketing pages (AMPs).

18. A network comprising:
a first server to transmit directory listings for service providers;
a second server to provide marketing content associated with one or more of the service providers to be included with the directory listings; and
one or more client computers, communicatively coupled to the server, to retrieve the directory listing and the marketing content.

19. The network of claim 18 further comprising a third server, coupled to the second server, to maintain access records for the second server.

20. The network of claim 18 wherein the second server comprises:
one or more service modules to generate the marketing content; and
a database to store data associated with the marketing content.

21. A method comprising:
receiving a request from a client computer at a first of a plurality of servers to transmit a directory listing;
transmitting the directory listing to the client computer;
receiving a request from the client computer at a second of a plurality of servers to transmit marketing content associated with the directory listing; and
transmitting the marketing content to the client computer.

22. The network of claim 21 wherein transmitting the directory listing to the client computer further comprises transmitting instructions that indicate which content items to request from the second server and how to display those items at the client computer.

23. The network of claim 21 further comprising the second server transmitting data to a third server indicating that the second server has been accessed by the client computer.

24. A method comprising:
receiving a request from a client computer at a first server to transmit a directory listing;
retrieving marketing content associated with the directory listing from a second of server; and
transmitting the directory and the marketing content to the client computer.
